(19) United States
(12) Patent Application Publication
(10) Pub. No.: US 2012/0144460 A1
(43) Pub. Date: Jun. 7, 2012

(54) METHODS AND DEVICES FOR ACCESS AUTHENICATION ON A COMPUTER

(76) Inventor: NETANEL RAISCH, Psagot (IL)

(21) Appl. No.: 12/961,513

(22) Filed: Dec. 7, 2010

(51) Int. Cl. H04L 9/32

(52) U.S. Cl. 726/5

(57) ABSTRACT

The invention discloses methods for preventing unauthorized and potentially illegal access to password-protected accounts. Specifically, the invention allows for inclusion of time-related data to distinguish between a human and computer as the source of a password, either in its creation or in its delivery to a server to gain access to a web-based account.

### FIELD AND BACKGROUND OF THE INVENTION

The present invention, in some embodiments thereof, relates to methods for preventing a dictionary attack on a server, but not exclusively, to methods for including time data associated with preparation or entering a PIN or password.

Much of social, commercial, banking, and personal life is tied up with personal identification numbers (PINs) or passwords. Bank accounts, personal data on social networking sites, access to work and school material are generally protected by PIN's and/or passwords. Passwords have become more and more sophisticated as methods for cracking passwords have become more developed: a typical password may have numerous characters that include numbers, capital letters, nonsense “words” and symbols such as exclamation points and the like. Even with such a move away from standard words, passwords are being compromised and data are being either stolen, modified, or analyzed. An expert blogger described the penetration of his blogs, even though he used a password “Ukyn762!”. Note that this password is a non-word, includes a capital letter, uses number and ends in an exclamation point. Even so, it was compromised as described: http://pacoup.com/2009/07/17/iframe-hack-and-security-dictionary-attacks-are-breazy-now/. The more complex passwords become, the more difficult it is to remember them, especially when one has multiple unique passwords for different accounts and applications.

The most common attack on a website, social network or bank server involves submitting literally millions of combinations of potential passwords to the relevant server. Usernames are often a person's first name, full name or some simple combinations of names and numbers. “Dictionary” attacks where millions of combinations of letters, numbers, and the like are combined and tried for PIN or password are the most notorious types of attacks. Dictionary attacks are often successful and lead to the compromise of important and/or sensitive material stored on a website or bank account. As many large websites that make use of username/password systems do not employ support staff to verify user data, a dictionary attack can send millions of potential passwords over a period of minutes without either staff or the host computer system noticing or taking evasive action (such as cutting off password attempts after three attempts).

U.S. Patent application number US 2002/0144158 to Hekimian describes a time domain protection system comprising a password of various letters that must be entered at specific clock times to have the password recognized as valid.

U.S. Pat. No. 6,954,862 to Serpa teaches a system and method for enhancing passwords, access codes, and personal identification numbers by making them pace, rhythm, or tempo sensitive. The password includes a sequence of characters and an associated timing element. To access a restricted device or function a user enters the correct character sequence according to the correct pace, rhythm, or tempo. The entered sequence and timing element are compared with stored values and access is granted only if the entered and stored values match. In an alternative embodiment the stored timing element is set, and periodically altered, by a computer or program without consent from the user and visual, auditory, and/or tactile prompts indicate the correct timing element to the user during the authentication process. The meaning of the prompts are provided to the user in advance.

U.S. Pat. No. 7,206,938 to Bender, et al teaches user recognition and identification system and method is presented in which text entered by a user at a keyboard is evaluated against previously recorded keystrokes by the user for the presence of repeatable patterns that are unique to an individual.

U.S. Pat. No. 7,266,693 to Potter, et al. describes method of authenticating a user through a validated mutual authentication system. In an exemplary embodiment, the method includes establishing a validating fractal image during an enrollment or other process. A plurality of fractal images are provided to a client during an authentication attempt by the user, and the plurality of fractal images includes the validating fractal image. Fractal image selection data is received from the client, and the system uses the received fractal image selection data to determine a fractal image selected by the user from the plurality of fractal images. The user is authenticated only if the fractal image selected by the user is the validating fractal image.

U.S. Pat. No. 7,305,559 to Schreiber, et al. teaches a software method of authentication is described that uses both relative and absolute values of inter-keystroke intervals measured during entry of a unique identifier. Both the relative and absolute values have to be achieved during entry of the unique identifier. The relative values are the ratio of each of the inter-keystroke intervals divided by one of the inter-keystroke intervals or divided by the average inter-keystroke interval.

The prior art generally describes methods for password verification that do not involve defining the time required to either enter a password or a component thereof.

### SUMMARY OF THE INVENTION

It is therefore a purpose of the present invention, in some embodiments, to describe methods for including time elements in some aspect of PIN or password verification so as to prevent dictionary attacks.

The invention includes a method for verifying a PIN or password at a server, including the following: receiving a first character of the PIN or password when the character is typed by a user; determining the clock time when the first character arrived at the server; receiving a last character of the PIN or password when the character is typed by user; determining the clock time when the last character of the PIN or the password arrived at the server; measuring clock time difference between receipt at the server of the first character and the last character of the PIN or password; determining if the time difference is greater than or equal to a predetermined time difference; and, allowing access to an account associated with the PIN or password if and only if the PIN or password is correctly entered and the time difference is greater than or equal to said predetermined time difference.

In one aspect of the method, the predetermined time difference is greater than or equal to one second.

In another aspect of the method, the first character and the last character include time clock data from the user's computer.

In another aspect of the method, the server is a plurality of servers.

In another aspect of the method, there is an additional step of measuring clock time at the server of at least one character in the middle of said PIN or password.

In another aspect of the method, there is an additional step of measuring the time difference in arrival at the server of at least two characters, at least one of the two characters being in the middle of said PIN or password.

In another aspect of the method, the PIN or password includes characters composed of letters, numbers, symbols, or a combination thereof.

In another aspect of the method, the letters are letters of the alphabet of any language.

In another aspect of the method, the clock time is measured by the server and may be either clock time or CPU time.

In another aspect of the method, the server is a single computer.

In another aspect of the method, there is an additional step of determining time between rejected PIN or password verification attempts.

In an additional aspect of the method, there is an additional step of permanently rejecting the PIN or password if time between the attempts is less than two seconds.

The invention additionally includes a method for creating a PIN or password of a user, including the following: providing the user with a visual, tactile, or audible display, wherein the display communicates a length of time a keyboard key associated with the computer is depressed; prompting a user to create a PIN or password, wherein at least one keyboard key associated with a character of the PIN or password will be depressed for two seconds or longer; measuring the time a keyboard key for each character of the PIN or password is depressed, wherein at least one key is depressed for two seconds or longer; and, displaying on the window the length of time each the key of the characters is depressed when the user creates the PIN or password.

In one aspect of the method, the at least one keyboard key is a plurality of keyboard keys.

In another aspect of the method, the window appears when the user is prompted to create or verify a password.

In another aspect of the method, there is an additional step of communicating to the user that his/her PIN or password has been created successfully, the PIN or password including both characters as well as a time of key depression component for at least one character.

In another aspect of the method, the PIN or password is associated with a online bank account, cloud computing service, social network, or computer account.

In another aspect of the method, the computer account is associated with an internet service site or computer account.

The invention additionally includes a method for accepting a PIN or password of a user, including the following: prompting the user to provide a PIN or password in order to enter an account associated with the PIN or password; verifying the PIN or password for correct characters and correct time of keyboard key depression for each character associated with the PIN or password; determining that the PIN or password matches a recorded PIN or password both in character order and keyboard key depression time, wherein at least one key associated with a character of the PIN or password is depressed for at least two seconds; and, allowing the user to access the account associated with said PIN or password, if and only if said PIN or password is correct both in character order and keyboard key time depression associated with at least one character of the PIN or password.

In one aspect of the method, there is an additional step of providing the user with a visual, audible, tactile display wherein the display communicates a length of time a keyboard key associated with the computer is depressed.

In another aspect of the method, there is an additional step of alerting the user that his/her PIN or password has been either accepted or rejected.

In another aspect of the method, the at least one character of the PIN or password must be depressed in excess of two seconds for the PIN or password to be accepted.

In another aspect of the method, the PIN or password includes letters, numbers, symbols, or a combination thereof.

In another aspect of the method, the keyboard depression time includes clock time data from the user's computer.

In another aspect of the method, there is an additional step of determining time between rejected PIN or password verification attempts.

In another aspect of the method, there is an additional step of permanently rejecting the PIN or password if time between the attempts is less than a predetermined time period.

In another aspect of the method, the predetermined time period is two seconds.

Unless otherwise defined, all technical and/or scientific terms used herein have the same meaning as commonly understood by one of ordinary skill in the art to which the invention pertains. “PIN”, “password”, “server”, “CPU”, “internet” “window” “dictionary attack” and “account” may have their generally understood meanings as applied in the computer arts. A “character” may generally refer to a letter, number, symbol or alphanumero that may be typed into a computer and may be part of a PIN or password. A “visual, tactile, or audible display” may refer to a screen, internet window or the like that allows for communication between a device user and his/her device. Typical such displays include but are not limited to computer windows on a screen as well as cell phone screens. A “device” may include a computer, cell phone, hand-held computing device or other electronic elements used for accessing and utilizing the internet. The system may also be used in the absence of internet, for uses such as file protection.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced. It is noted that similar elements in various drawings will have the same number, advanced by the appropriate multiple of 100.

In the drawings:

FIGS. 1A & 1B are schematic representations of an embodiment of the present invention;

FIG. 2 is a flowchart for a method associated with the first embodiment;

FIG. 3 is a schematic representation of a second embodiment of the present invention;

FIG. 4 is a flowchart for a method associated with the second embodiment;

FIG. 5 is a schematic representation of an embodiment as taught in the instant invention; and,

FIG. 6 is a flowchart associated with a third embodiment.

### DESCRIPTION OF SPECIFIC EMBODIMENTS OF THE INVENTION

The present invention, in some embodiments thereof, relates to more secure methods for transmitting and verifying passwords and, more particularly, but not exclusively, to methods for preventing dictionary and similar computer attacks.

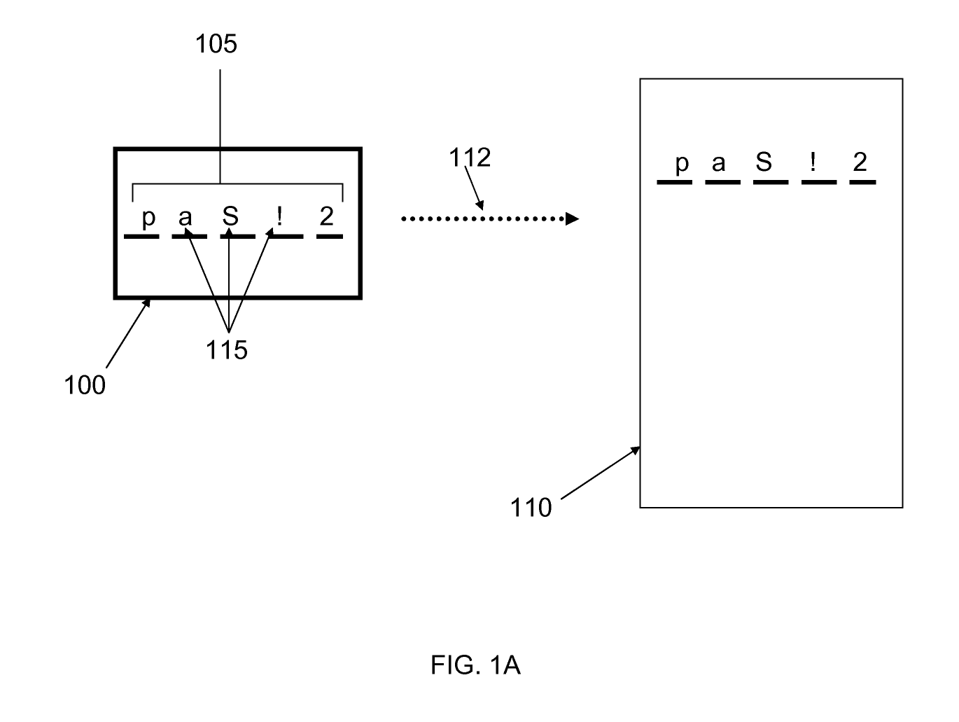

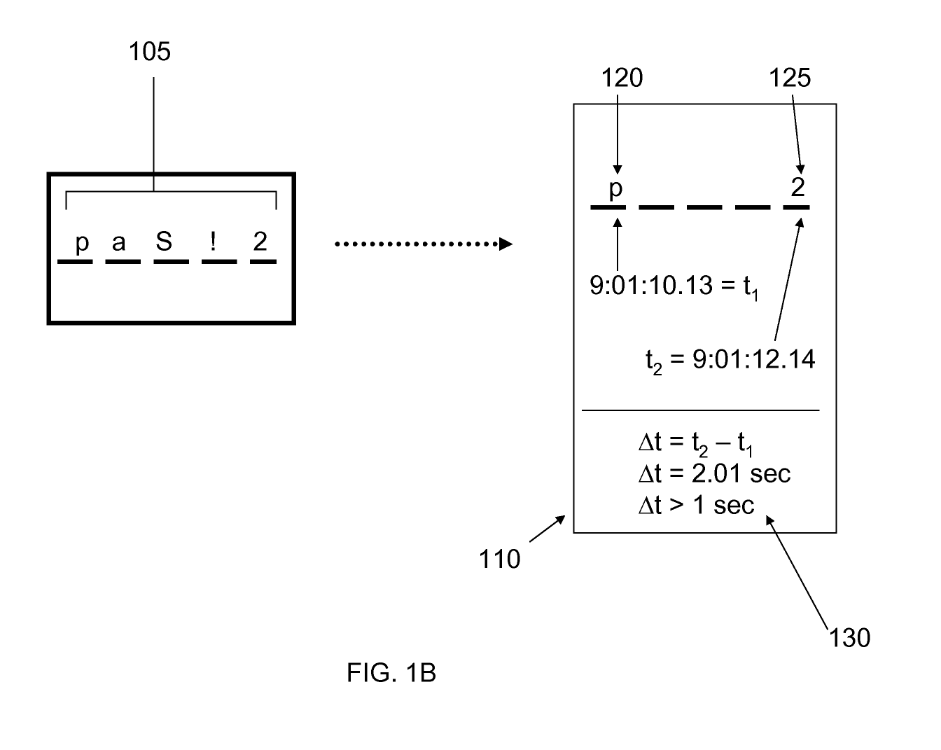

For purposes of better understanding some embodiments of the present invention, as illustrated in FIGS. 1-6 of the drawings, reference is first made to the first embodiment as shown in FIG. 1A.

### First Embodiment

FIG. 1A shows a schematic representation of an embodiment of the present invention. In FIG. 1A, a user (not shown) working at a computer 100 enters a password (paS!2) 105 that is relayed via the internet 112 to a server 110 at a location distinct from the location of said computer 100. According to certain aspects of the invention, when user enters each letter/number/symbol 115 (“p”, “a” “S” “!” “2”) associated with said password 105, the specific letter/number/symbol is sent to said server 110. Thus, server 110 receives the password 105 piecemeal and not as one unit after the user has fully typed into his/her computer 100 the password 105. The user may still hit return/enter at the end of typing of the password 105, even though all of the password 105 has been transferred from the computer 100 to the server 110 at the time of typing each character of said password 105.

As shown in FIG. 1B, the server 110 records the arrival time of minimally the first and last letter/number/symbol 115 of the password 105. The server 110 may record additional times of characters in the middle of the password 105. As shown in FIG. 1B, the first character (“p”) 120 of the password 105 arrived at the sever 110 at 9:01:10.13 am (9:01 and 10.13 seconds in the morning, t₁). The final character (“2”) 125 of the password 105 arrived at the server 110 at 9:01:12.14 (9:01 and 12.14 seconds in the morning, t₂). The difference in arrival times for the first character 120 of the password 105 and the last character 125 of the password 105 is 2.01 seconds. As the difference in time 130 is greater than one second as measured by the server 110 (and merely as supplied by the user), the server 110 concludes that the user is a person and not merely a device running a dictionary or similar attack, wherein passwords are sent to server in microseconds to milliseconds. The server 110 allows the user access to his/her account associated with the password 105.

It is understood that the invention as described in the first embodiment can additionally or alternatively accept clock times provided by the clock or CPU of the user's computer (FIG. 1A, 100). It is also understood that should a user erase a letter/number/symbol during the time that he/she types in the password 105, the server 110 responds accordingly by removing the character in the password 105 as received at the server 110. The server does not reset the clock time for measuring how long it takes user to enter his/her password 105. As one of the purposes of the present invention is to clearly identify a erasure and retyping only makes it more likely that a human and not a computer or “bot human as the provider of a PIN or password 105, the additional time associated with” is actually providing the password 105 being entered.

Dictionary and similar server attacks generally submit hundreds of thousands or millions of combinations of letters/numbers/symbols with the hope of successfully entering a correct password and gaining access to someone else's computer account or the like. Dictionary attacks rely on speed—presenting enormous numbers of potentially correct passwords in seconds to minutes. In the present invention, in some embodiments, the server 110 receiving a password 105 will record and analyze a PIN or password both for its correctness (the right letters, numbers, symbols in the right order with any features such as capital letters and/or spaces) as well as the clock time at which parts of the password arrived at said server 110. A human cannot generally enter a password with a keyboard (physical or virtual, as with an iPhone) in less than one second. Thus, while a dictionary attack scheme may present a full password to a server 110 in a millisecond, a human-generated password would require at least one second to enter and transmit. Even if a new generation of dictionary attacks attempted to delivery each password in 1-2 second intervals, the length of time required to send millions of potential password would be so long as to make the potential return unattractive to hackers and the like.

Dictionary attacks could include ersatz time data with each character, in an attempt to fool a server 110 that a human was actually entering the password 105. By including time data specifically on the server 110 end (either without time data from the computer 100 or with such data), the server 110 can determine if the password 105 was sent in a second or longer or was generated by a computer with the malicious intent to hijack a computer account.

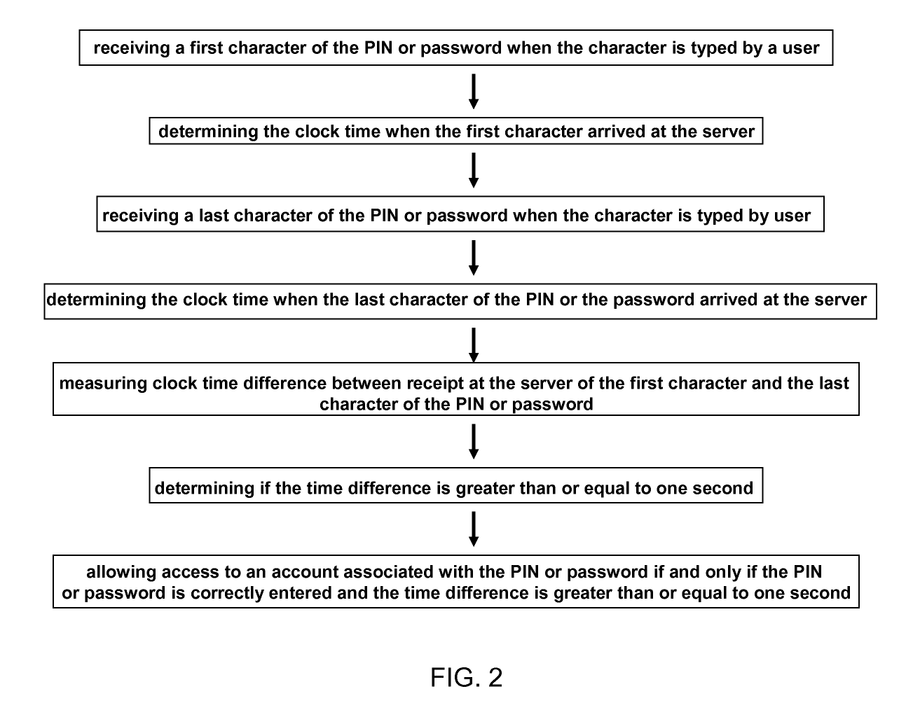

Attention is turned to FIG. 2, which shows a flowchart for a method associated with the first embodiment of the instant invention. Specifically, the method allows for identification of human sending of a PIN or password. FIG. 2 describes a method for verifying a PIN or password at a server, including the following: receiving a first character of the PIN or password when the character is typed by a user; determining the clock time when the first character arrived at the server; receiving a last character of the PIN or password when the character is typed by user; determining the clock time when the last character of the PIN or the password arrived at the server; measuring clock time difference between receipt at the server of the first character and the last character of the PIN or password; determining if the time difference is greater than or equal to one second; and, allowing access to an account associated with the PIN or password if and only if the PIN or password is correctly entered and the time difference is greater than or equal to one second. Ostensibly, the user would not have to type “enter” after finishing password entry, as the server will have already received the last character of the password (such is the case with many ATM machines that immediately provide service with entry of a PIN number). That said, one would allow for user typing of “enter” or “return” after finishing typing of password.

In very rare cases, such as when a PIN or password is extremely short and the user is a very fast typist, the time between receipt of first and last character may be under one second. In such a case in the present invention, the user may receive an error that the password entered was not valid. As human response time and communication time for any reasonable PIN or password would be greater than one second—and far in excess of the milliseconds used in dictionary attacks—it is believed that the vast majority of reasonable passwords will require more than one second to be typed and received by server and thus appropriate for the instant invention. In the event that a user has a pre-saved or auto-written password, the instant invention includes a program that can send each character of the password to a server, with time spacing between characters predetermined to allow for successful acceptance of the password.

### Second Embodiment

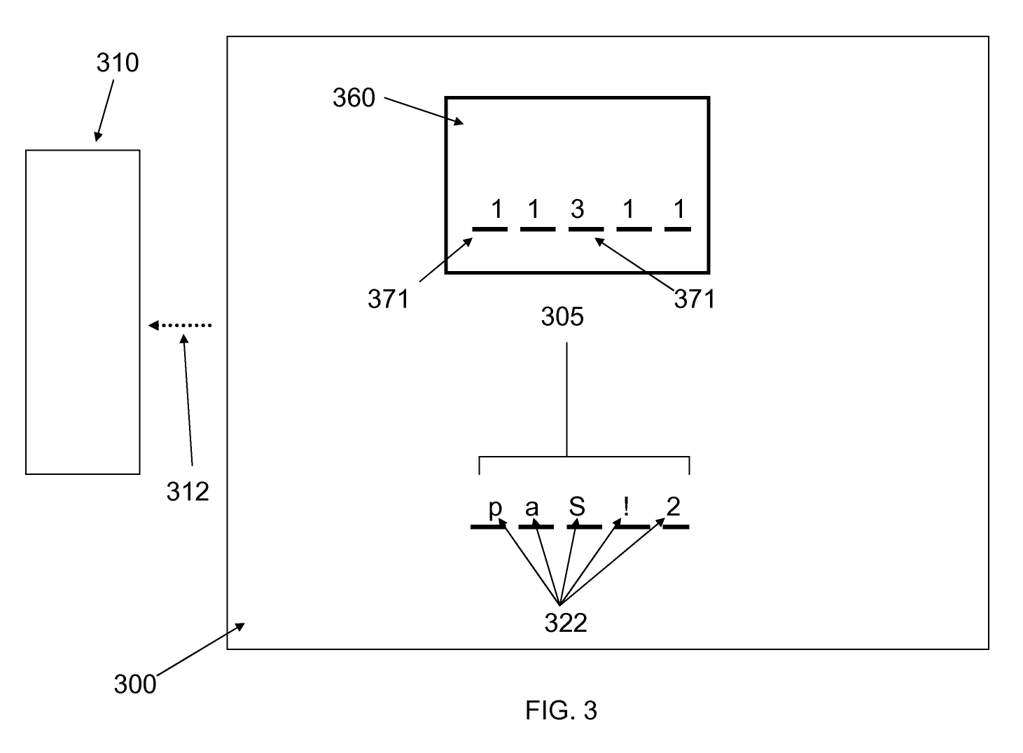

Attention is turned to FIG. 3. A computer screen 300 shows a password 305 being entered for the first time by a user (not shown). In this embodiment, a program, website or the like has asked user to create a new password. The password “paS!2” is typed on the computer screen 300. On the same computer screen 300 there is provided an internet window 360 which shows for every password character 322 typed the corresponding time for which the relevant keyboard key was depressed (p→1; a→1; S→3; 2→1; !→1). This information is provided in real time on the screen 300 and seconds are rounded up (there are no zero values, though there can be if the time is alternatively rounded down). Thus, as user enters the letter “p” and he/she presses on the keyboard key corresponding to “p” for say a tenth of a second, the number “1” appears in position 371 on the internet window. And so on for the remaining characters of the password and their corresponding time data as displayed in the internet window 360. One will notice that at position 373, “3” appears, implying that the user pressed the key “S” (note capital) for greater than two seconds and less than or equal to three seconds. By doing so, a number larger than one was recorded at position 373 of internet window 360. When user has finished entering password 305, the data—characters and time for key depression—are sent via internet 312 to a server 310.

In the present embodiment, at least one character of the password 305 will generally be depressed for greater than two seconds. The number of characters that must be depressed in excess of this predetermined time value can be changed, as can the predetermined required time for key depression (it could be two seconds or five seconds, for example). If user simply enters “p-a-S-2--!” without holding down one of the keys for a period in excess of two seconds, then the receiving server will send back a message stating that there has been an error in password or PIN creation (not shown). The present embodiment requires a time element in excess of two seconds for at least one character, and in this figure, that character is the “S” of the password (as per user choice). When user has entered the password with both characters and at least one character being entered for two seconds or longer (for example), then upon sending the password to the relevant server (not shown), the server will accept the password and send back notification that the password has been accepted. In the future, user will have to remember the password “paS2!” and that the letter “S” must be depressed in excess of two seconds. See Third Embodiment for more details. One could make embodiments of the present invention, where the extended key depression could either be an exact amount of time, between a predetermined range (say between 2 and 5 seconds) or must be over some threshold (as in the present case, more than 2 seconds).

By holding down a keyboard key on a standard physical keyboard, a user in essence types the same letter a large number of times. For example, holding the “a” key for three seconds would yield the following result: aaaaaaaaaaaaaaaaaaaaaaaaaaaaaaaaaaaaaaaaaaaaaaaaaaaaaaaaaaaaaaaaaaaaaaaaaaaaa aaaaaa. Thus, the present invention can determine how long a user held down a particular character key (letter/number/symbol) by the number of times that same character appears to have been typed. In the example above for the letter “a”, by depressing the key corresponding to “a” for three seconds, 83 letters “a” were typed. Thus, for a non-digital keyboard, the length of time a key is depressed is directly proportional to the number of times the letter would appear to have been typed. For a digital keyboard, the length of time that one's finger is in contact with a touch-sensitive screen can be determined through electrical connectivity between finger and (glass) screen. In this example the letter “S” would not appear 83 times on the screen; rather, the user's depression of capital “S” for three seconds would be known to have been accomplished when a program of the present invention times the key depression, possibly by the number of times “S” would have appeared on the screen if allowed. Alternatively, a program of the present invention could measure the time when a given key was depressed and when the same key was subsequently released. The program would then confirm that the key was depressed for a given period of time above and include this time data in the password data sent to a server.

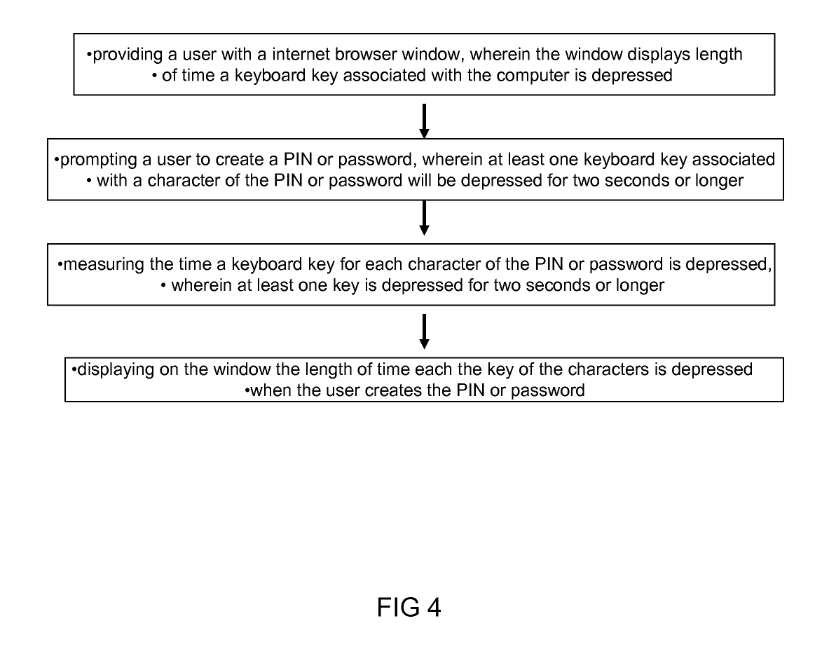

Attention is turned to FIG. 4, which shows a flowchart associated with the second embodiment. The flowchart describes a method for creating a PIN or password of a user, including the following: providing the user with a internet browser window, wherein the window displays length of time a keyboard key associated with the computer is depressed; prompting a user to create a PIN or password, wherein at least one keyboard key associated with a character of the PIN or password will be depressed for two seconds or longer; measuring the time a keyboard key for each character of the PIN or password is depressed, wherein at least one key is depressed for two seconds or longer; and, displaying on the window the length of time each the key of the characters is depressed when the user creates the PIN or password.

### Third Embodiment

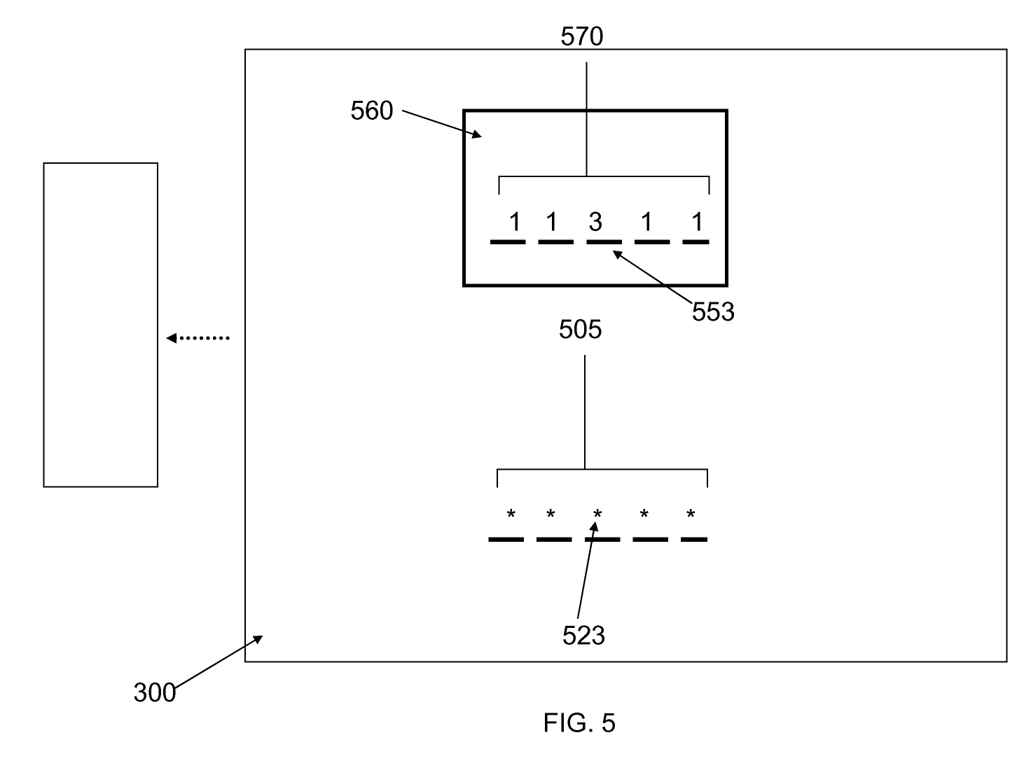

Attention is turned to FIG. 5 which shows a schematic representation of a third embodiment of the present invention. In this embodiment, password data including characters and at least one time feature are used to successfully enter a web-based computer account or the like. A user (not shown) enters a password 505 on his/her computer, cell phone, tablet computer, iPod or other similar internet-active device. The password may appear on the screen 500 as written or it may appear as asterisks (as shown in FIG. 5) or other symbols in place of the actual characters typed by user. During the time when user is entering his/her password 505, an internet screen 560 shows the length of time that each key corresponding to a character in the password 505 is depressed. One will note that the third character 523 shows a corresponding key depression time 553 in the internet window 560 of three (3) seconds. When the entire password 505 has been typed, user will type “enter” or “return” and the password, both characters and key depression time data, will be sent via internet 512 to a server 510 for verification. If the characters of the password 505 and the key depression time data 570 match the information stored on the server, 510, user will be granted access to his/her web-based account. If either the characters or the key depression time data 570 are incorrect, server 510 will send a corresponding message to user via his/her computer screen 500.

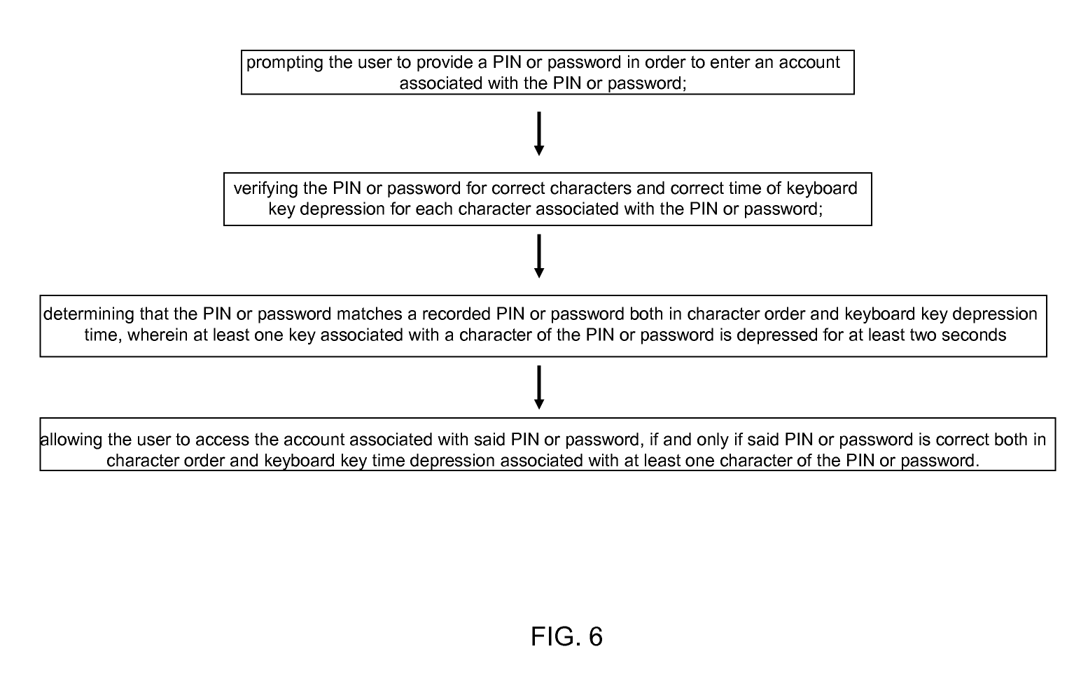

FIG. 6 shows method associated with the third embodiment of the instant invention. FIG. 6 details a method for accepting a PIN or password of a user, including the following: prompting the user to provide a PIN or password in order to enter an account associated with the PIN or password; verifying the PIN or password for correct characters and correct time of keyboard key depression for each character associated with the PIN or password; determining that the PIN or password matches a recorded PIN or password both in character order and keyboard key depression time, wherein at least one key associated with a character of the PIN or password is depressed for at least two seconds; and, allowing the user to access the account associated with said PIN or password, if and only if said PIN or password is correct both in character order and keyboard key time depression associated with at least one character of the PIN or password. In this embodiment, an internet window is not provided for user when he/she enters password for gaining access to a web-based account. A window can optionally be provided to aid in determining the length of time at least one key associated with a character of the password is depressed.

It is expected that during the life of a patent maturing from this application variable computer security technologies will be developed and the scope of the term of the invention is intended to include all such new technologies a priori.

As used herein the term “about” refers to ±10%.

The terms “comprises”, “comprising”, “includes”, “including”, “having” and their conjugates mean “including but not limited to”.

The term “consisting of means “including and limited to”.

The term “consisting essentially of means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. The present invention can be employed in web-based applications that require PIN or password approval or alternatively in free-standing systems such as ATM machines. It can additionally allow for protection of data files or computer access in single computers.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method for authenticating a PIN or password at a server, including the following:
receiving a first character of said PIN or password when said character is typed by a user;
determining the clock time when said first character arrived at said server;
receiving a last character of said PIN or password when said character is typed by user;
determining the clock time when said last character of said PIN or said password arrived at said server
measuring clock time difference between receipt at said server of said first character and said last character of said PIN or password;
determining if said time difference is greater than or equal to a predetermined time difference; and,
allowing access to an account associated with said PIN or password if and only if said PIN or password is correctly entered and said time difference is greater than or equal to said predetermined time difference.

2. The method according to claim 1, wherein said predetermined time difference is greater than or equal to one second.

3. The method according to claim 1, wherein said first character and said last character include time clock data from said user's computer.

4. The method according to claim 1, wherein said server is a plurality of servers.

5. The method according to claim 1, further including the step of measuring clock time at said server of at least one character in the middle of said PIN or password.

6. The method according to claim 1, further including the step of measuring the time difference in arrival at said server of at least two characters, at least one of said two characters being in the middle of said PIN or password.

7. The method according to claim 1, wherein said PIN or password includes characters composed of letters, numbers, symbols, or a combination thereof.

8. The method according to claim 7, wherein said letters are letters of the alphabet of any language.

9. The method according to claim 1, wherein said clock time is measured by said server and may be either clock time or CPU time.

10. A method for creating a PIN or password of a user, including the following:
providing said user with a visual, audible or tactical display, wherein said display may communicate a length of time a keyboard key associated with said computer is depressed;
prompting a user to create a PIN or password, wherein at least one keyboard key associated with a character of said PIN or password will be depressed for two seconds or longer;
measuring the time a keyboard key for each character of said PIN or password is depressed, wherein at least one key is depressed for two seconds or longer; and,
displaying on said window the length of time each said key of said characters is depressed when said user creates said PIN or password.

11. The method according to claim 10, wherein said at least one keyboard key is a plurality of keyboard keys.

12. The method according to claim 10, wherein said window appears when said user is prompted to create or verify a password.

13. The method according to claim 10, further including the step of communicating to said user that his/her PIN or password has been created successfully, said PIN or password including both characters as well as a time of key depression component for at least one character.

14. The method according to claim 10, wherein said PIN or password is associated with an online bank account, cloud computing service, social network or computer account.

15. The method according to claim 14, wherein said computer account is associated with an internet service site.

16. A method for accepting a PIN or password of a user, including the following:
prompting said user to provide a PIN or password in order to enter an account associated with said PIN or password;
verifying said PIN or password for correct characters and correct time of keyboard key depression for each character associated with said PIN or password;
determining that said PIN or password matches a recorded PIN or password both in character order and keyboard key depression time, wherein at least one key associated with a character of said PIN or password is depressed for at least two seconds; and,
allowing said user to access said account associated with said PIN or password, if and only if said PIN or password is correct both in character order and keyboard key time depression associated with at least one character of said PIN or password.

17. The method according to claim 16, further including the step of providing said user with a visual, audible or tactile display, wherein said display communicates a length of time a keyboard key associated with said computer is depressed.

18. The method according to claim 16, further including the step of alerting said user that his/her PIN or password has been either accepted or rejected.

19. The method according to claim 16, wherein at least one character of said PIN or password must be depressed in excess of two seconds for said PIN or password to be accepted.

20. The method according to claim 16, wherein said PIN or password includes letters, numbers, symbols, or a combination thereof.

21. The method according to claim 16, wherein said keyboard depression time includes clock time data from said user's computer.

22. The method according to claim 16, further including the step of determining time between rejected PIN or password verification attempts.

23. The method according to claim 22, further including the step of permanently rejecting said PIN or password if time between said attempts is less than a predetermined time period.

24. The method according to claim 1, wherein said server is a single computer.

25. The method according to claim 1, further including the step of determining time between rejected PIN or password verification attempts.

26. The method according to claim 25, further including the step of permanently rejecting said PIN or password if time between said attempts is less than two seconds.

27. The method according to claim 23, wherein said predetermined time period is two seconds.
